(19) United States
(12) Patent Application Publication
(10) Pub. No.: US 2006/0184666 A1
(43) Pub. Date: Aug. 17, 2006

(54) Anonymity service providing system, device, and program

(76) Inventors: Yukiteru Nozawa, Urayasu-shi (JP); Takehisa Kato, Kunitachi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/353,997

(22) Filed: Feb. 15, 2006

(30) Foreign Application Priority Data
Feb. 16, 2005 (JP) 2005-039421

(51) Int. Cl. G06F 15/173

(52) U.S. Cl. 709/224

(57) ABSTRACT

Provided is an anonymity service providing system for authenticating an anonymous user device based on a group signature and providing service to the user device, the system comprising a group management institute device which manages a plurality of groups in the group signature system, a user device belonging to at least one the groups, and a service use situation for each user device, promotes a user device to change a group in response to a use situation, and changes a group based on a change request received from the user device, a service provider device which sets in advance a condition for promoting change of a group to the group management institute device, and provides service to a user device, and a user device which, when change of a group is promoted from the group management institute device, transmits a change request to the group management institute device.

### CROSS-REFERENCE TO RELATED APPLICATIONS

This application is based upon and claims the benefit of priority from prior Japanese Patent Application No. 2005-039421, filed Feb. 16, 2005, the entire contents of which are incorporated herein by reference.

### BACKGROUND OF THE INVENTION

1. Field of the Invention

The present invention relates to an anonymity service providing system, device, and program for providing service by anonymity authentication using a group signature system. In particular, the present invention relates to an anonymity service providing system, device, and program capable of individually approaching an anonymous user in anonymity authentication.

2. Description of the Related Art

In general, a service provider using a network has a demand for individually approaching users without collecting the users' privacy information. The term “approach” denotes proposing a talk for sales promotion. Cookie is generally known as a technique for the purpose of approach. However, Cookie is invalid for a user terminal that cannot handle Cookie and a user terminal set as Cookie rejection from the viewpoint of security.

On the other hand, instead of the technique for the purpose of approach, there is a technique for a service provider to provide service to an anonymous user without collecting the user's privacy information. As this technique, there is known a technique using a group signature system. The group signature system is a kind of digital signing. The group signature system is a technique of proving validity of signature without presenting a signature verifier with signer's unique information (privacy information. More specifically, the group signature system configures a group composed of signers having signature keys that are different from each other. In addition, a group signature is generated by an arbitrary signature key in a group. In the group signature system, a group to which a signer belongs can be specified without specifying the signer based on a group signature. A person who can specify a signer from a group signature is limited to a manager of the group (refer to, for example, paragraph [0025] of Jpn. Pat. Appln. KOKAI Publication No. 2004-54905).

A related application of Jpn. Pat. Appln. KOKAI Publication No. 2004-54905 includes U.S. application Ser. No. 10/445,911. This U.S. application Ser. No. 10/445,911, filed on May 28, 2003, is hereby incorporated herein by reference.

FIGS. 1 to 3 are a functional block diagram and sequence charts adopted to illustrate an access control system described in Jpn. Pat. Appln. KOKAI Publication No. 2004-54905, respectively. The access control system is configured by a group management institute device 10, a user device 20, and a service provider device 30.

The group management institute device 10 corresponds to a manager in a group signature system. The group management institute device 10 comprises an information management unit 11, an information examining unit 12, a group key generating unit 13, a privileged information generating unit 14, a restoration processing unit 15, a settlement management unit 16, an accounting processing unit 17, and an authority examining unit 18.

The user device 20 corresponds to a signer in a group signature system. The user device 20 comprises a privilege information management unit 21, a user information management unit 22, a privilege key generating unit 23, a privileged information verification unit 24, a privilege certifying unit 25, and a service request unit 26.

The service provider device 30 corresponds to a signature verifier in a group signature system. The service provider device 30 comprises an access control unit 31, a challenge generating unit 32, a privilege verification unit 33, a service management unit 34, and a use management unit 35.

When new registration is carried out in a group of a group signature system, the user device 20, as shown in FIG. 2, generates a privilege key (signature key) and causes the group management institute device 10 to issue privileged information (member certificate).

The user device 20, as shown in FIG. 3, causes the service provider device 30 to certify information for receiving service without presenting privacy information (user information), and receives the service from the service provider device 30. The service provider device 30 transmits use information (use history) and privileged information in association with each other each specified period, and then, causes the group management institute device 10 to collect a use charge from a user.

In this way, according to a technique described in Jpn. Pat. Appln. KOKAI Publication No. 2004-54905, the fact that the user device 20 belongs to a privileged group is certified to the service provider device 30 by using a group signature. Therefore, there is no need for a service provider to manage the user's privacy information. Thus, the service provider can reduce a burden on managing privacy information. The user can protect privacy information unnecessary to certify privilege from the service provider (refer to paragraph [0139]).

There is no problem in particular in the foregoing technique described in Jpn. Pat. Appln. KOKAI Publication No. 2004-54905.

However, according to discussion of the inventors, the technique described in Jpn. Pat. Appln. KOKAI Publication No. 2004-54905 still has a room to be improved from the viewpoint of meeting a “demand for individually approaching users without collecting the users' privacy information. This applies to a system for providing service by anonymity authentication using a group signature system without being limited to the technique described in Jpn. Pat. Appln. KOKAI Publication No. 2004-54905.

### BRIEF SUMMARY OF THE INVENTION

It is an object of the present invention to provide an anonymity service providing system, device, and program capable of individually approaching anonymous users in anonymity authentication.

According to a first aspect of the present invention, there is provided an anonymity service providing system which authenticates an anonymous user device based on a group signature system for certifying that an anonymous user belongs to a group, and provides service to the user device, the system comprising: a group management institute device which manages a plurality of groups in the group signature system, a user device belonging to at least one of the groups, and a service use situation of each user device, promotes a user device to change a group in response to the use situation, and changes a group based on a change request received from the user device; a service provider device which sets in advance a condition for promoting change of the group to the group management institute device, and provides service to the user device; and a user device which, when change of a group is promoted from the group management institute device, transmits the change request to the group management institute device by means of a user's operation.

According to a second aspect of the present invention, there is provided an anonymity service providing system which authenticates an anonymous user device based on a group signature system for certifying that an anonymous user belongs to a group, and provides service to the user device, the system comprising: a group management institute device which manages a plurality of groups in the group signature system, a user device belonging to at least one of the groups, and a service use situation of each user device, promotes a user device to newly register a group in response to the use situation, and newly registers a group based on a new registration request received from the user device; a service provider device which sets in advance a condition for promoting new registration of the group to the group management institute device, and provides service to the user device; and a user device which, when new registration of a group is promoted from the group management institute device, transmits the new registration request to the group management institute device by means of a user's operation.

According to a third aspect of the present invention, there is provided an anonymity service providing system which authenticates an anonymous user device based on a group signature system for certifying that an anonymous user belongs to a group, and provides service to the user device, the system comprising: a group management institute device which manages a plurality of groups in the group signature system, a user device belonging to at least one of the groups, and a service use situation of each user device, promotes a user device to newly register into a sales promotion target group in response to the use situation, and newly registers into a sales promotion target group based on a new registration request received from the user device; a service provider device which sets in advance a condition for promoting new registration into the sales promotion target group to the group management institute device, and provides service to the user device; and a user device which, when new registration into a sales promotion target group is promoted from the group management institute device, transmits the new registration request to the group management institute device by means of a user's operation.

In the first to third aspects, the contents of approaching a user device are: promotion of change of a group; promotion of new registration of a group; and promotion of new registration into a sales promotion target group.

The service provider device presets a condition for approaching a user device in response to a service use state to a group management institute device. Then, the group management institute device approaches a user device in response to a service use state on a user device by user device basis.

Therefore, according to the first to third aspects, individual approaches to anonymous users in anonymous authentication can be achieved.

### BRIEF DESCRIPTION OF THE SEVERAL VIEWS OF THE DRAWING

FIG. 1 is a functional block diagram adopted to illustrate a conventional access control system;

FIG. 2 is a sequence chart adopted to illustrate the conventional access control system;

FIG. 3 is a sequence chart adopted to illustrate the conventional access control system;

FIG. 4 is a functional block diagram depicting a configuration of an anonymity service providing system according to a first embodiment of the present invention;

FIG. 5 is a sequence chart adopted to illustrate an operation in the embodiment;

FIG. 6 is a schematic view adopted to illustrate a group change condition setting in the embodiment;

FIG. 7 is a schematic view adopted to illustrate storage of use information in the embodiment;

FIG. 8 is a schematic view adopted to illustrate a process for changing a group in the embodiment;

FIG. 9 is a functional block diagram depicting a configuration of an anonymity service providing system according to a second embodiment of the present invention;

FIG. 10 is a functional block diagram depicting a configuration of an anonymity service providing system according to a third embodiment of the present invention;

FIG. 11 is a functional block diagram depicting a configuration of an anonymity service providing system according to a fourth embodiment of the present invention;

FIG. 12 is a sequence chart adopted to illustrate an operation in the embodiment;

FIG. 13 is a schematic view adopted to illustrate a group definition or the like in the embodiment;

FIG. 14 is a functional block diagram depicting a configuration of a anonymity service providing system according to a fifth embodiment of the present invention;

FIG. 15 is a sequence chart adopted to illustrate an operation in the embodiment; and

FIG. 16 is a schematic view adopted to illustrate a process for newly registering a group in the same embodiment.

### DETAILED DESCRIPTION OF THE INVENTION

Now, embodiments of the present invention will be described with reference to the accompanying drawings. First, a general description of each of the embodiments will be given below. The embodiments each describe that individual approaches such as sales promotion are achieved in response to a service use situation for anonymous users in anonymity authentication. The term “individual” used here denotes each user included in a user group that conforms to a condition specified by a service provider. The service provider cannot identify each user. In addition, the term “sales promotion” is a called promotion and denotes general sales promotion means. The sales promotion means include promoting a change of a group and providing a discount coupon or the like to an anonymous person who has used one's own service.

More specifically, in a first embodiment, an approach is carried out such that a service provider promotes group members set and defined by a group management institute to make a change to a premium group. Second and third embodiments are provided as modified examples of the first embodiment, wherein the service provider device or group management institute device selects a group as a change destination. In a fourth embodiment, a service provider makes a group definition, entrusts management to a group management institute, and carries out an approach in response to a use record or the like. In a fifth embodiment, a service provider causes a group management institute to extract a user who conforms to one's own use record condition, and a group management institute carries out an approach provided by a service provider in a substitutive manner.

Subsequently, such embodiments will be specifically described here.

### First Embodiment

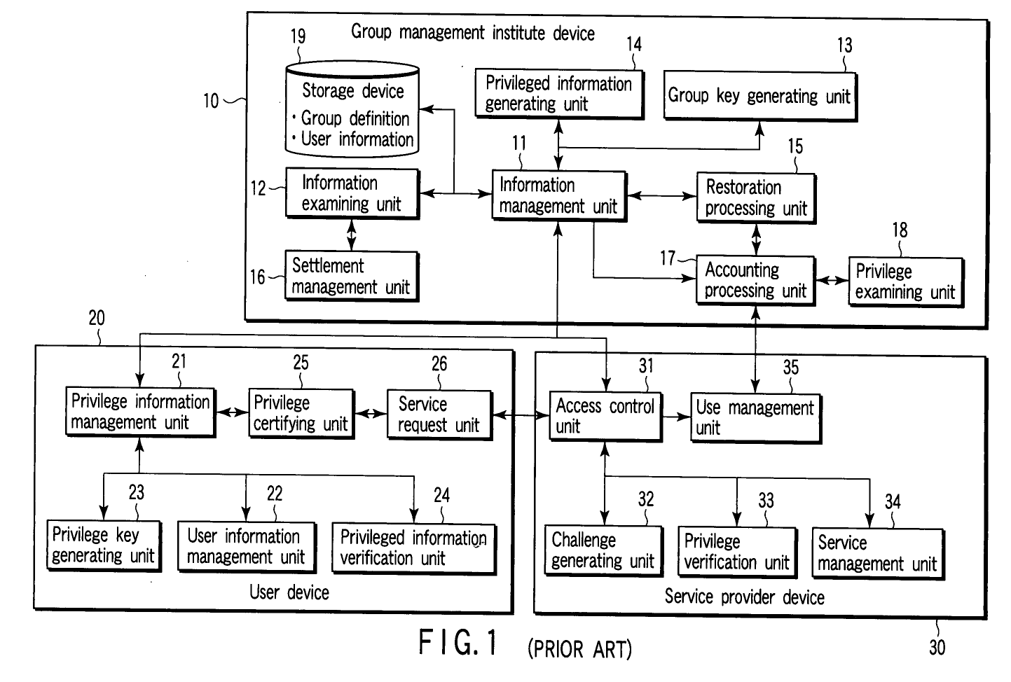

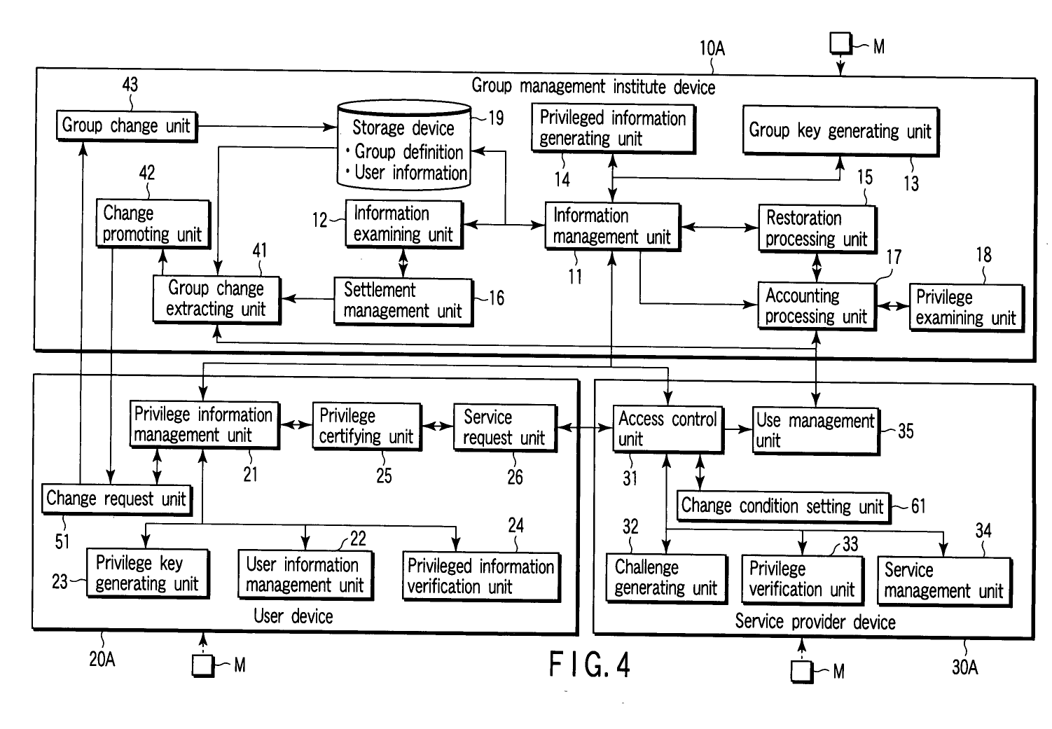

FIG. 4 is a functional block diagram depicting a configuration of an anonymity service providing system according to a first embodiment of the present invention. Here, like constituent elements in FIG. 1 are designated by like reference numerals. A detailed description thereof is omitted here, and different elements will be primarily described here. With respect to the following embodiments as well, a duplicate description is omitted similarly.

In the present embodiment, it is possible to provide an approach for promoting change of groups individually to anonymous users in anonymity authentication. The anonymity service providing system according to the embodiment comprises a group management institute device 10a, a user device 20A, and a service provider device 30A. Each of the devices 10A, 20A and 30A can be implemented by hardware and/or software. In the case of using software, programs indicating operations of the software are installed in advance in computers of the devices 10A, 20A and 30A. These programs are stored in advance in a computer readable storage medium M, and comprise program codes for computers to execute functions of these devices. Such embodiments of the devices using hardware and/or hardware are similar in the embodiments described below.

The group management institute device 10A further comprises a group change extracting unit 41, a change promoting unit 42, and a group change unit 43 in comparison with the group management institute device 10 described previously. The group management institute device 10A also has a storage device 19 which is hardware in which a group definition, user information and the like are stored.

The group change extracting unit 41 has the following functions (f41-1) and (f41-2):

(f41-1) a function for, when transmission of use information or the like in step ST31 occurs, referring to a settlement management unit 16 based on information on a group change promotion condition in the storage device 19 and extracting information on a target for group change promotion; and

(f42-1) a function for sending out the extracting result to the change promoting unit 42.

The change promoting unit 42 transmits information on group change promotion to the user device 20A based on the extracting result caused by the group change extracting unit 41.

Upon the receipt of a group change request from the user device 20A, the group change unit 43 has a function for carrying out a process for changing a group on a user by user basis with respect to a storage device 19.

The user device 20A further comprises a change request unit 51 in comparison with the user device 20 described previously.

The change request unit 51 has the following functions (f51-1) and (f51-2):

(f51-1) a function for displaying received information on group change promotion on a screen; and

(f51-2) a function for transmitting a group change request (privileging request) to the group management institute device 10A by means of a user's operation.

The service provider device 30A further comprises a change condition setting unit 61 in comparison with the service provider device 30 described previously.

The change condition setting unit 61 sets to the group management institute device 10A information on a group change promotion condition of one's own service user via the access control unit 31 by means of an operation of a service provider.

This type of group is set for a user by a group management institute such as a communication carrier, for example. Examples of groups include group A consisting of basic members, and group B consisting of premium members. Group A is defined for, for example, a user with a small amount of packets. Group B is defined for a user with a large amount of packets. A service provider promotes change to group B in response to a use situation via the group management institute, thereby promoting use of one's own service.

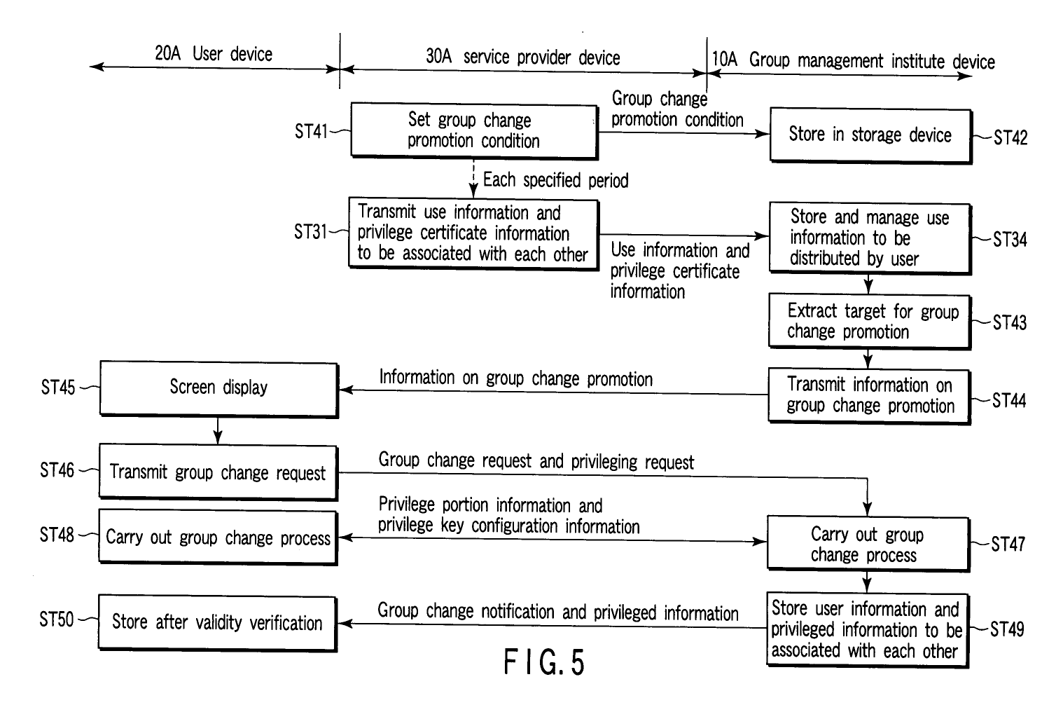

Now, an operation of the anonymity service providing system configured above will be described with reference to a sequence chart shown in FIG. 5.

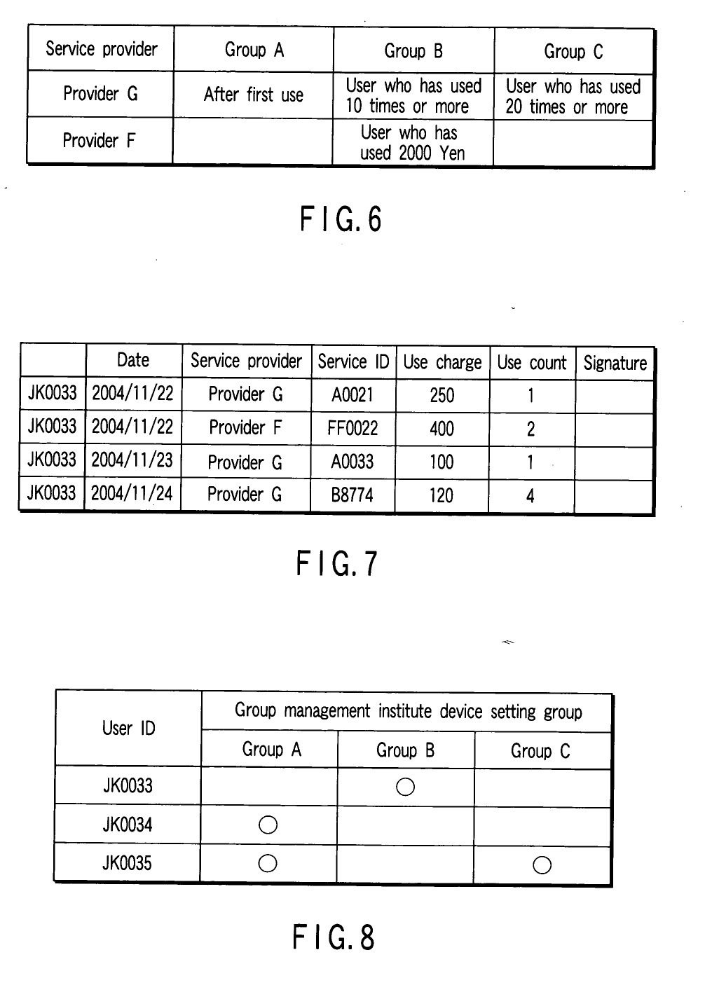

In the service provider device 30A, the change condition setting unit 61 sets to the group management institute device 10A a group change promotion condition of one's own service user, as shown in FIG. 6, via the access control unit 31, by means of an operation of a service provider. (ST41). The group change promotion condition, for example, includes promoting a change from group A (basic members) to group B (premium members) with respect to a user who has used one's own service 10 times.

The group management institute device 10A causes the information management unit 11 to store this condition in the storage device 19 (ST42).

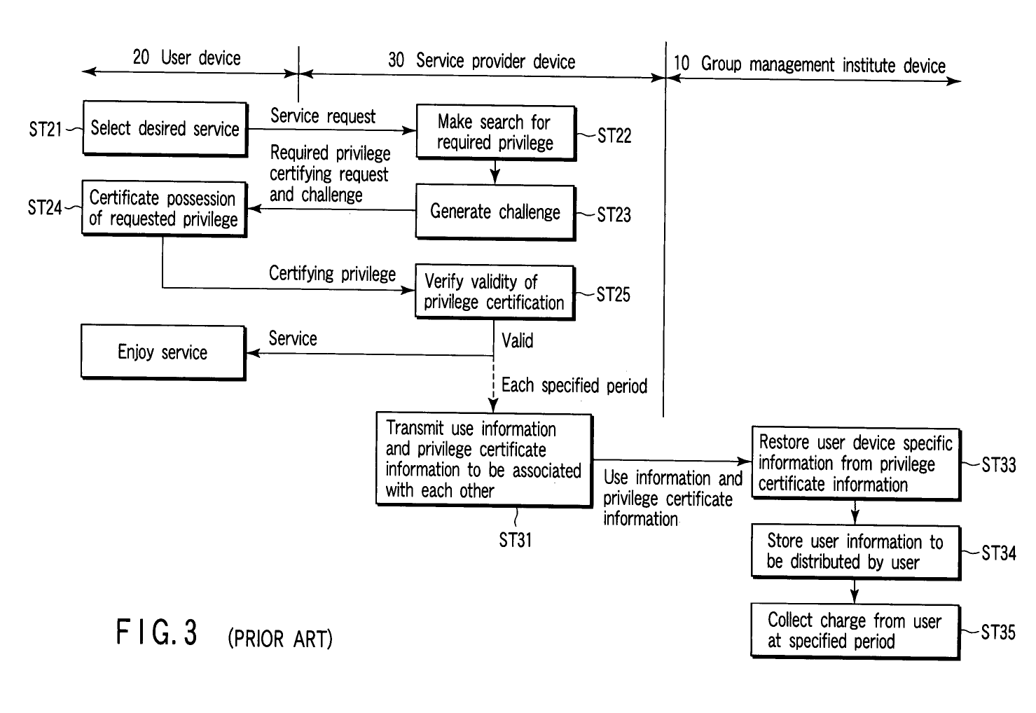

Having received a service request from the user device 20A, the service provider device 30A provides service to the user device 30A as shown in FIG. 3 (ST21 to ST25). For example, since a user belongs to group A (basic members), the corresponding contents of group A are transmitted to the user device 20A.

Then, the service provider device 30A transmits to the group management institute device 10A use information (use state) and privilege certificate information to be associated with each other each specified period (ST31).

The group management institute device 10A specifies a user based on the transmitted contents (ST33), and stores use information to be distributed on a user by user basis as shown in FIG. 7 (ST34). Then, the group management institute device 10A collects a charge from the user in a specified period (ST35).

The contents of steps ST21 to ST35 are described in detail in Jpn. Pat. Appln. KOKAI Publication No. 2004-54905 and U.S. application Ser. No. 10/445,911, and denote service provision due to general anonymity authentication, management of a user situation, and a settlement process.

Subsequently, in the group management institute device 10A, the group change extracting unit 41 operates when transmission of use information or the like in step ST31 occurs. The group change extracting unit 41 checks a settlement situation of a user with reference to the settlement management unit 16 based on the use information and the group change promotion condition contained in the storage device 19. When a settlement situation is good, the group change extracting unit 41 extracts (identification information of the user device 20A of) a target for group change promotion from use information (ST43). The extracting result is sent out from the change extracting unit 41 to the change promoting unit 42.

The change promoting unit 42 transmits information on group change promotion (URL for group change) to the user device 20A based on the extracting result (ST44). The information includes, for example, a change promotion message from group A to group B and URL of change registration page.

In the user device 20A, the change request unit 51 writes the received information on group change promotion in a memory, and displays the written information on a screen (ST45). In the case where a user wants to change a group, the change request unit 51 provides an access to the notified URL by means of the user's operation, and transmits a group change request (privileging request) to the group management institute device 10A (ST46). The group change request is a request for making change or registration from group A to group B, for example.

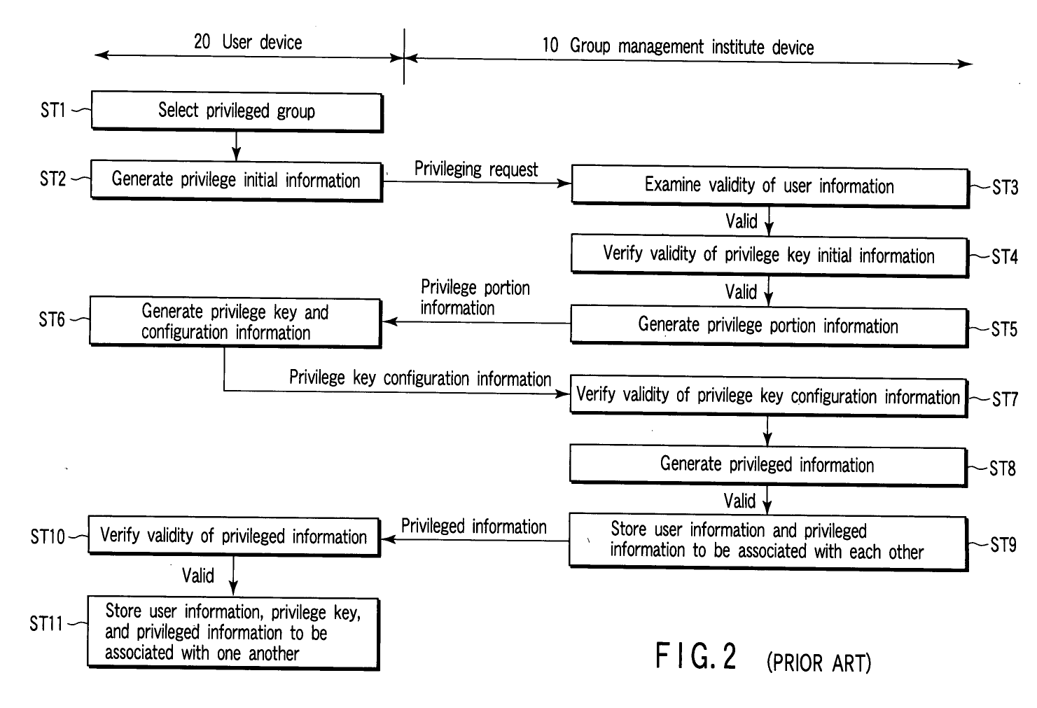

When the group management institute device 10A receives this group change request, the group change unit 43 carries out a process for changing a group on a user by user basis with respect to the storage device 19, as shown in FIG. 8 (ST47 to ST50). The group change process includes the same contents as those of a new group registration process. In more detail, the processing shown in FIG. 2 is executed.

In this manner, the group change process completes.

The user device 20A belongs to group B after changed and can receive provision of service from the service provider device 30A in the same way as that described previously. Of course, the available service includes the contents according to group B after changed.

According to the present embodiment as described above, the service provider device 20A sets in advance to the group management institute device 10A a condition for promoting change of a group to a user device in response to a service use situation. The group management institute device 10A transmits information on group change promotion to the user device 20A in response to a service use situation on a user by user basis device 20A.

Therefore, in the case where the content of approaching the user device 20A is “group change promotion”, the service provider can approach anonymous users in anonymity authentication individually.

In the case where there is approval from a user in advance, modification may be made so as to omit transmission of change promotion information to the user device 20A, reception of a group change request from the user device 20A, and the like and so that the group management institute device 10A automatically changes a group.

In any case, the service provider can achieve avoidance of a burden and a risk associated with user enclosing and user information storage.

The group management institute can provide high-value added service to a service provider and can improve sales due to change from one's own set group members to a high-value added group.

Even an anonymous user can receive service according to a use record or information provision oriented to preference.

### Second Embodiment

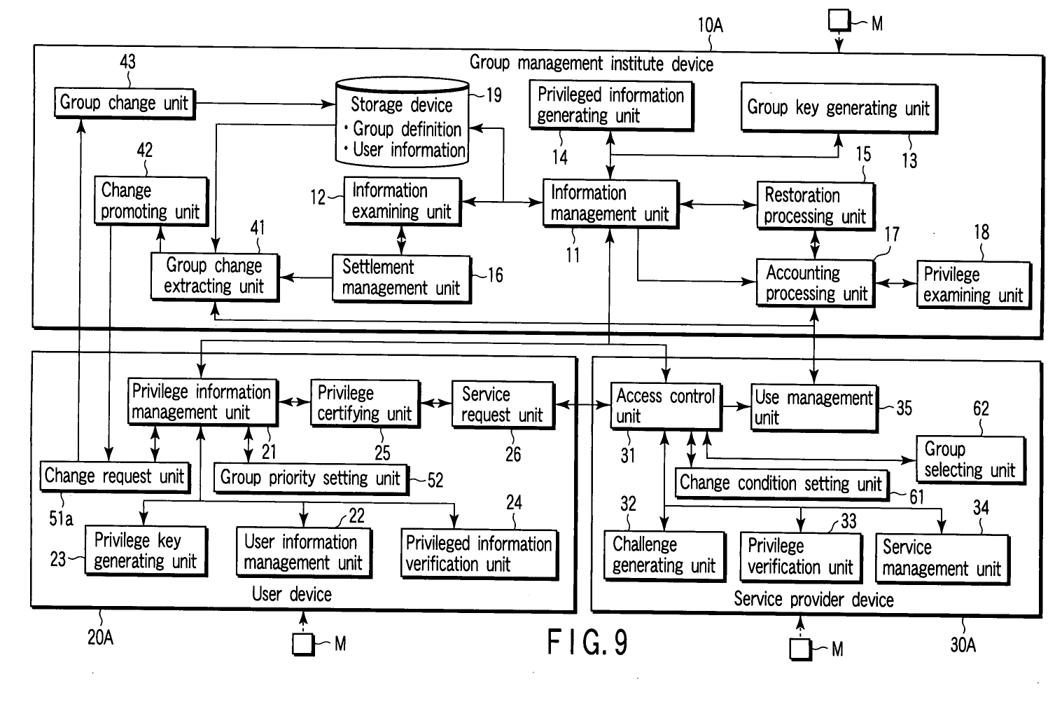

FIG. 9 is a functional block diagram depicting a configuration of an anonymity service providing system according to a second embodiment of the present invention.

The present embodiment is provided as a modified example of the first embodiment, wherein, in the case where a user belongs to a plurality of groups, the user has a configuration of causing a service provider to select an advantageous group. More specifically, the user device 20A comprises a group priority setting unit 52 and a change request unit 51a obtained by adding a function for making inquiry to the change request unit 51 described previously.

The group priority setting unit 52 sets priorities by a plurality of groups in advance by means of a user's operation.

The change request unit 51a has a function for transmitting information on a group targeted for comparison and information on a group targeted for change promotion to the service provider device 30A by means of the user's operation while group change promotion information in step ST45 is displayed on a screen. The information on a group targeted for comparison includes priorities of items such as charge and genre. In addition, the change request unit 51a has a function for transmitting to the group change unit 43 a new registration/change request to a group selected by the service provider device 30A.

Concurrently, the service management unit 34 of the service provider device 30A has a function for receiving the information on a group targeted for comparison and information on a group targeted for change promotion from the user device 20A. The service management unit 34 also has a function for selecting a group advantageous to a user based on the received information and one's own campaign information and transmitting the selection result to the user device 20A.

For example, let us consider a case of a user having high priority of charge and low priority of genre (for example, Western music or classical music). In the case where high priority is assigned to charge, a group promoted for change is selected when change is promoted for a reason of low charge.

On the other hand, let us consider a case of a user having low priority of charge and high priority of genre (for example, Western music or classical music). In the case where high priority is assigned to genre, a comparison target group is selected even if another genre is promoted for change for a reason of low charge. These examples have described a case in which judgment is easy for the purpose of convenience. In actuality, however, a group can be selected even in the case where judgment is difficult by setting priorities in more detail.

With a configuration as described above, judgment of the user group selection can be assisted by a service provider in addition to the advantageous effect of the first embodiment.

### Third Embodiment

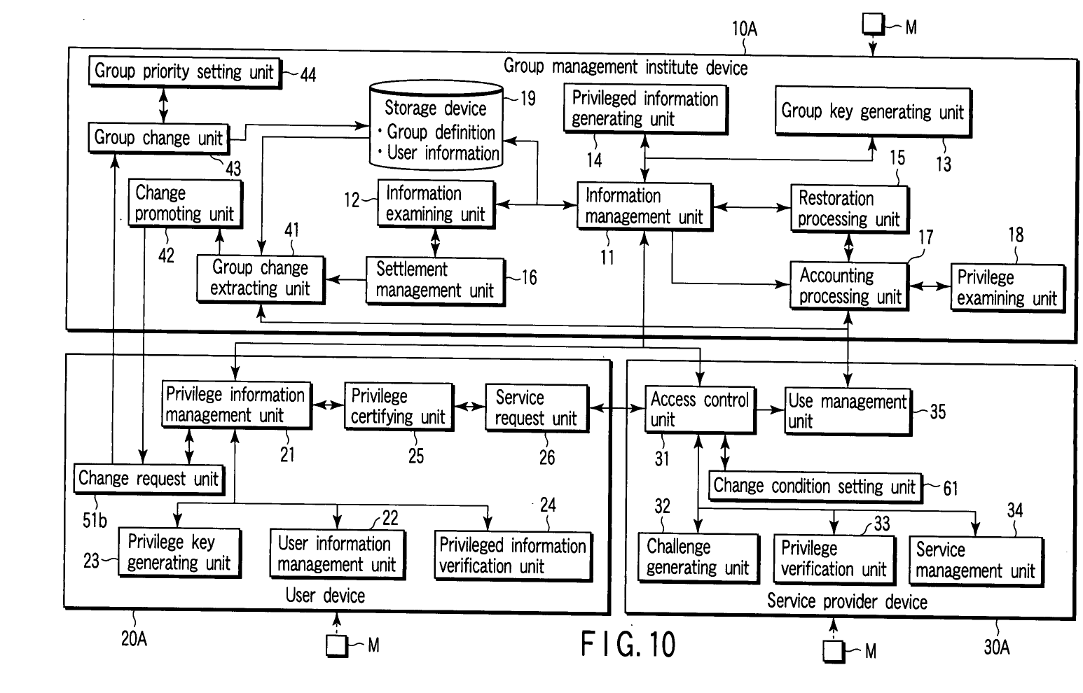

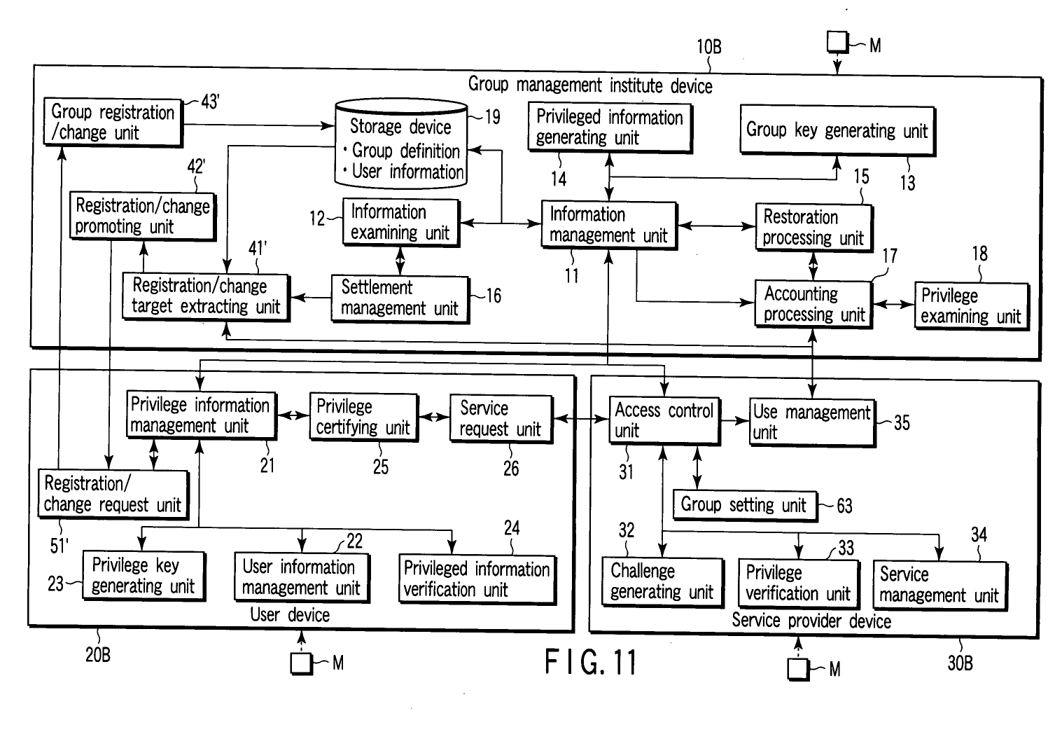

FIG. 10 is a functional block diagram depicting a configuration of an anonymity service providing system according to a third embodiment of the present invention.

The present embodiment is provided as a modified example of the first embodiment, wherein, in the case where a user belongs to a plurality of groups, a group management institute device is caused to select an advantageous group. More specifically, the group management institute device 10A comprises a group priority setting unit 44, and a group change unit 43 having added thereto a function for changing a group with reference to the group priority setting unit 44.

The group priority setting unit 44 sets in advance a priority of each plural group by means of an operation of a manager entrusted from a service provider.

In addition to the functions described above, the group change unit 43 has the following functions (f43-1) and (f43-2):

(f43-1) a function for, when a group selecting request is received from the user device 20A, selecting a group advantageous to a user with reference to the group priority setting unit 44; and

(f43-2) a function for sending the selection result back to the user device 20A.

In addition to the functions of the change request unit 51 described previously, a change request unit 51b has the following functions (f51b-1) and (f51b-2):

(f51b-1) a function for transmitting a group selecting request to the group management institute device 10A by means of a user's operation during screen display of information on group change promotion in step ST45; and

(f51b-2) a function for receiving information on a group selected by the group management institute device 10a, and displaying the received information on a screen.

The change request unit 51b transmits a group change request to the group change unit 43 by means of the user's operation, as described previously. The group change unit 43 executes a group changing process based on the change request, as described previously.

With the configuration described above, the judgment of the user group selection can be assisted by a group manager in addition to the advantageous effect of the first embodiment.

### Fourth Embodiment

FIG. 11 is a functional block diagram depicting a configuration of an anonymity service providing system according to a fourth embodiment of the present invention.

The present embodiment is provided as a modified example of the first embodiment, enabling an approach for individually promoting new registration of anonymous users in anonymity authentication into one's own group. Specifically, the devices 10A to 30A in FIG. 4 are partially changed, and there are provided a group management institute device 10B, a user device 20B, and a service provider device 30B.

Instead of the devices 41 to 43 described previously, the group management institute device 10B comprises a registration/change target extracting unit 41′, a registration/change promoting unit 42′, and a group registration/change unit 43′ obtained by partially changing the above devices.

When transmission of use information or the like in step ST31 occurs, the registration/change target extracting unit 41′ refers to the settlement management unit 16 based on information on a new group registration/change promotion condition in the storage device 19, and extracts information on a person targeted for new group registration/change promotion. The registration/change target extracting unit 41′ has a function for sending out the extracting result to the registration/change promoting unit 42′.

The registration change promoting unit 42′ transmits information on new group registration/change promotion to the user device 20B based on the extracting result caused by the registration/change target extracting unit 41′.

The group registration/change unit 43′ having received a new group registration/change request from the user device 20B carries out a new registration/change request process of a group on a user by user basis with respect to the storage device 19.

The user device 20B comprises, in stead of the change request unit 51 described previously, a change request unit 51b that partially changes the function of the change request unit 51.

The change request unit 51b has the following functions (f51b-1) and (f51b-2):

(f51b-1) a function for displaying received information on new group registration/change promotion on a screen; and

(f51b-2) a function for transmitting a new group registration/change request (privileging request) to the group management institute device 10B by means of a user's operation.

The service provider device 30B comprises a group setting unit 63 instead of the change condition setting unit 61 described previously.

The group setting unit 63 defines a group of one's own service user via the access control unit 31 by means of an operation of a service provider, and then, sets a condition for promoting the new registration/change to the group management institute device.

This type of group is defined so that a service provider, for example, a communication provider organizes one's own users. After definition, the setting is entrusted to the group management institute. The service provider defines, for example, group A (=light user members) and group B (heavy user members). Next, the service provider guides a user having a predetermined number of uses to group B so as to be a fixed customer from among the users belonging to group A. An example of guidance includes a guide sign indicating that privilege such as a discount coupon is given if entering group B. Thus, the service provider enables guidance for guiding a user to a fixed customer even if individual users cannot be specified.

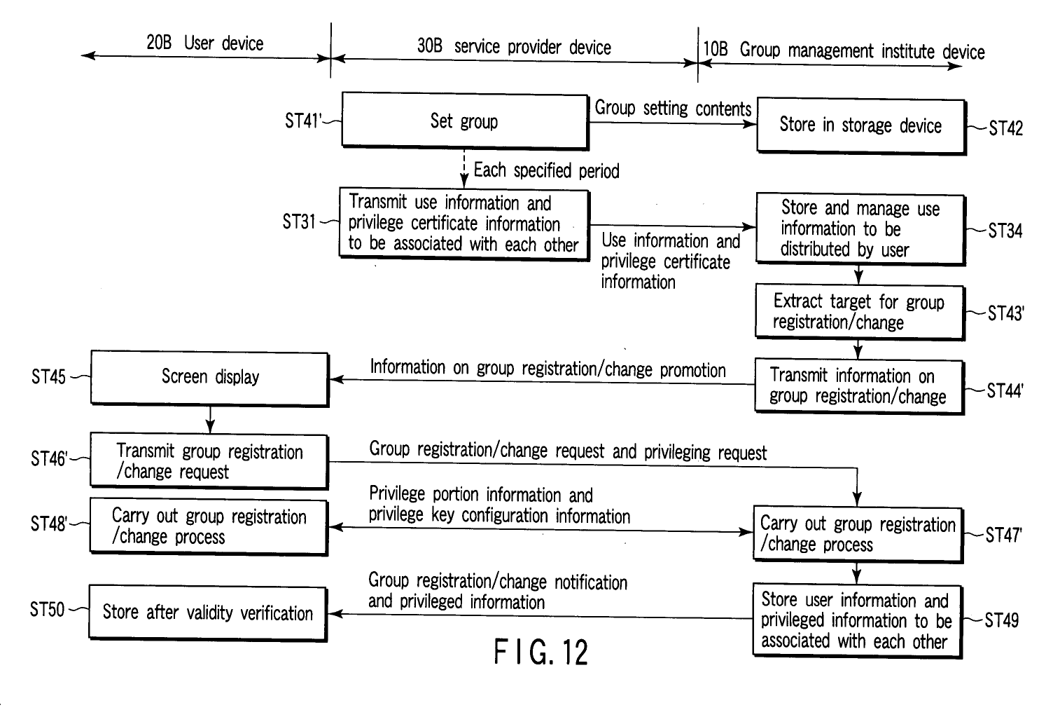

Now, an operation of the anonymity service providing system configured above will be described with reference to a sequence chart shown in FIG. 12.

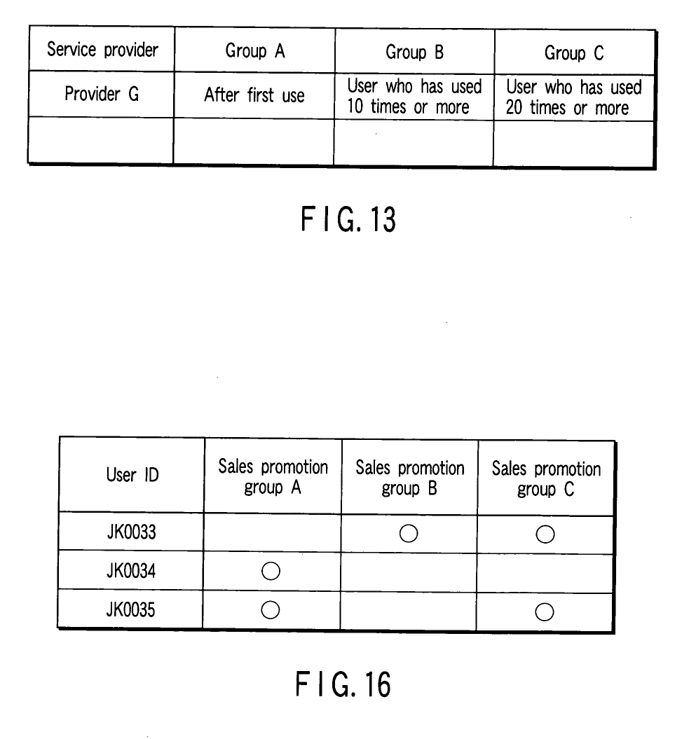

In the service provider device 30B, the group setting unit 63 sets a group via the access control unit 31 by means of an operation of a service provider (ST41′). More specifically, the group setting unit 63 sets definition of a group of one's own service user and a condition for new registration/change promotion to the group management institute device 10B. As shown in, for example, FIG. 13, with respect to a user who has used one's own service 10 times, a condition for promoting new registration in group B (heavy user members) instead of group A (light user members) is set to the group management institute device 10B.

The group management institute device 10B causes the information management unit 11 to store the contents of the settings in the storage device 19 (ST42).

The service provider device 30B having received a service request from the user device 20B in the same manner as that described previously provides service to the user device 20B as shown in FIG. 3 (ST21 to ST25). Although a user at this stage is a group member of the group management institute, he or she is not a group member of the service provider. Thus, as service to be provided, for example, general contents are transmitted to the user device 20B.

Then, steps ST31 to ST35 are executed in the same manner as that described previously.

Subsequently, in the group management institute device 10B, the registration/change target extracting unit 41′ operates when transmission of use information (use situation) or the like in step ST31 occurs. The registration change target extracting unit 41′ refers to the settlement management unit 16 based on the group a registration/change condition in the storage device 19, and extracts (the user device 20B of) a person targeted for group registration/change promotion (ST43′). The extracting result is sent to the registration change promoting unit 42′.

The registration change promoting unit 42′ transmits information on group registration/change promotion (URL for group registration/change) to the user device 20B based on this extracting result (ST44′). The information includes, for example, a message for promoting new registration into group B and URL of new registration page.

In the user device 20B, the change request unit 51b writes the received information on new group registration promotion in a memory, and then, displays the written information on a screen (ST45). In the case where a user wants to make new group registration, the change request unit 51b provides an access to the notified URL by means of the user's operation, and then, transmits a new group registration request (privileging request) to the group management institute device 10B (ST46′). The new group registration request is provided as, for example, a request for making new registration into group B.

When the group management institute device 10B receives this new group registration request, the group registration/change unit 43′ carries out a new group registration process on a user by user basis with respect to the storage device 19 (ST47′ to ST50). This new group registration process includes the same contents as those of the new group registration process. In more detail, the process shown in FIG. 2 is executed.

In this manner, a new group registration process completes.

Then, the user device 20B belongs to group B after newly registered, and can receive provision of service from the service provider device 30B in the same manner as that described previously. Of course, the available service includes the contents according to group B after newly registered.

According to the present embodiment as described above, the service provider device 30B sets in advance to the group management institute device 10B a condition for promoting new registration/change into one's own group to the user device in response to a service use situation. The group management institute device 10B transmits information on new registration/change promotion into a group of a service providing company to the user device 20B in response to a service use situation of each user device 20B.

Therefore, when the contents of approaching user devices are defined as new group registration/change promotion, individual approach to anonymous users in anonymity authentication can be achieved.

### Fifth Embodiment

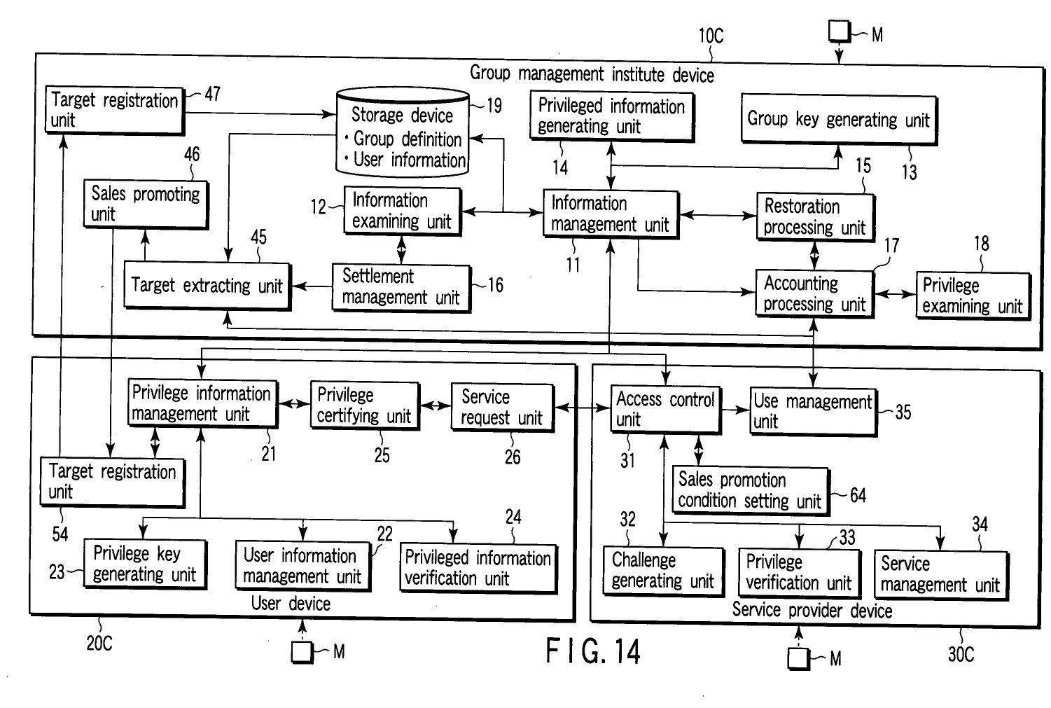

FIG. 14 is a functional block diagram depicting a configuration of an anonymity service providing system according to a fifth embodiment of the present invention.

The present embodiment is provided as a modified example of the fourth embodiment, enabling an approach for individually promote anonymous used in anonymous users in anonymous authentication to make new registration into a group targeted for sales promotion. More specifically, the devices 10B to 30B in FIG. 11 are partially changed, and there are provided a group management institute device 10C, a user device 20C, and a service provider device 30C.

The group management institute device 10B comprises a target extracting unit 45, a sales promoting unit 46, and a target registration unit 47 instead of the devices 41′ to 43′ described previously.

The target extracting unit 45 has the following functions (f45-1) and (f45-2):

(f45-1) a function for, when transmission of use information or the like in step ST31 occurs, referring to the settlement management unit 16 based on information on a sales promotion target condition stored in the storage device 19, and extracting information on a sales promotion target; and

(f45-2) a function for sending out the extracting result to the sales promoting unit 46.

The sales promoting unit 46 transmits information on sales promoting for the user device 20C based on the extracting result caused by the target extracting unit 45.

The target registration unit 47 having received a new registration request for a sales promotion target group from the user device 20C carries out a process for new registration into a sales promotion target group on a user by user basis with respect to the storage device 19.

The user device 20C comprises, instead of the change request unit 51 described previously, a target registration unit 54 obtained by partially changing the function of the change request unit 51.

The target registration unit 54 has the following functions (f54-1) and (f54-2):

(f54-1) a function for displaying the received sales promotion on a screen; and

(f54-2) a function for transmitting a new registration request (privileging request) for the sales promotion target group to the group management institute device 10C by means of the user's operation.

The service provider device 30C comprises a sales promotion condition setting unit 64 instead of the change condition setting unit 61 described previously.

The sales promotion condition setting unit 64 sets to the group management institute device 10C items of information on a condition on a sales promotion target of one's own service and a sales promotion method via the access control unit 31 by means of an operation of a service provider.

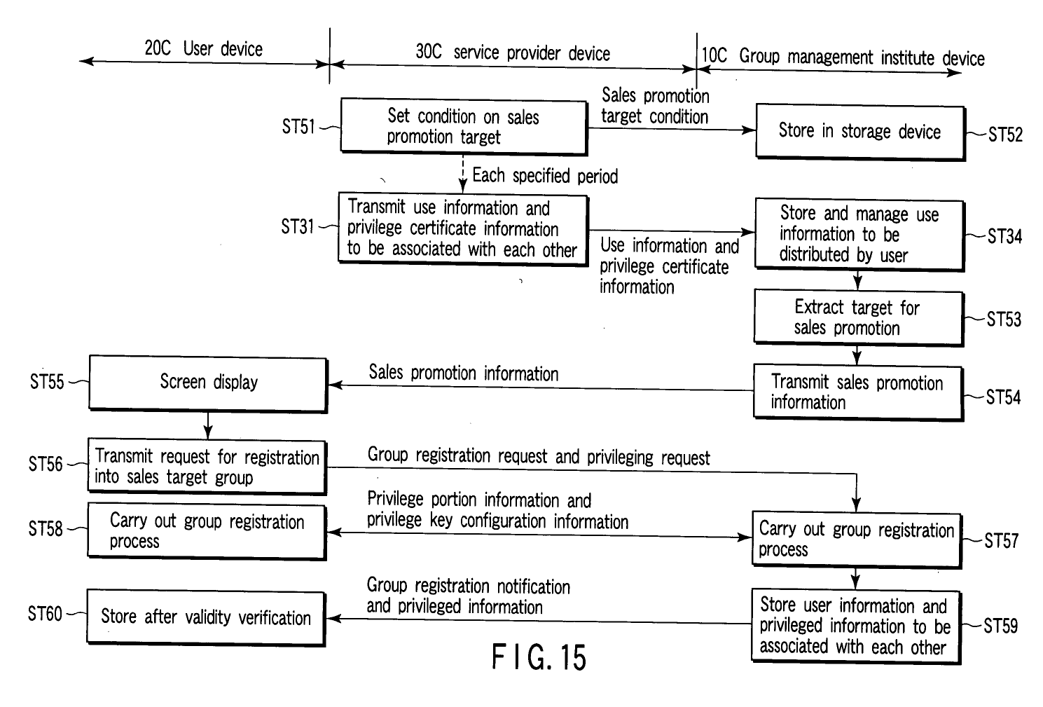

Now, an operation of the anonymity service providing system configured above will be described with reference to a sequence chart shown in FIG. 15.

In the service provider device 30C, the sales promotion condition setting unit 64 sets to the group management institute device 10C a condition on a sales promotion target and a sales promotion method via the access control unit 31 by means of an operation of a service provider (ST51). The condition on a sales promotion target includes, for example, a user who has utilized A0001 to A9999 of a Western service ID 10 times from among the users having used one's own service 10 times. The sales promotion method includes, for example, issuance of a half-price sale coupon.

The group management institute device 10C causes the information management unit 11 to store the contents of setting in the storage device 19 (ST52).

The service provider device 30C having received a service request from the user device 20C similarly provides service to the user device 20C as shown in FIG. 3 (ST21 to ST25). Then, steps ST31 to ST35 are executed in the same way as that described previously.

Subsequently, in the group management institute device 10C, the target extracting unit 45 operates when transmission of use information (use situation) or the like in step ST31 occurs. The target extracting unit 45 refers to the settlement management unit 16 based on a condition on a sales promotion target stored in the storage device 19, and extracts (the user device 20C of) the sales promotion target (ST53). The extracting result is sent out to the sales promoting unit 46.

The sales promoting unit 46 transmits information on sales promotion for the user device 20C (URL for obtaining a half-price sale coupon) based on this extracting result (ST54). The information includes, for example, a new registration promotion message for a sales promotion target group and URL of new registration page.

In the user device 20C, the target registration unit 54 writes the received information on sales promotion into a memory, and displays the written information on a screen (ST55). In the case where a user wants to obtain a half-price sale coupon, the target registration unit 54 provides an access to the notified URL by means of a user's operation, and transmits a new registration request (privileging request) for the sales promotion target group to the group management institute device 10C (ST56).

When the group management institute device 10C receives this new registration request, the target registration unit 47 carries out a process for newly registering into a sales promotion target group on a user by user basis with respect to the storage device 19 (ST57 to ST60). The new group registration process includes the same contents as that of new group registration process. In more detail, the process shown in FIG. 2 is executed.

In this manner, a new group registration process completes as shown in FIG. 16.

Hereinafter, the user device 20C belongs to a sales promotion target group after newly registered, and can receive from the service provider device 20 provision of sales promotion service such as issuance of a half-price sale coupon in the same manner as that described previously. In addition, of course, the user device 20C also belongs to the existing group, and thus, can receive service of the existing group by using the half-price sale coupon of the sales promotion target group.

According to the present embodiment as described above, the service provider device 30C sets in advance a condition on a sales promotion target to the user device in response to a service use situation with respect to the group management institute device 10C. The group management institute device 10C transmits information for promoting the user device 20C to make new registration into a sales promotion target group in response to a service use situation of each user device 20C.

Consequently, when the contents of approaching the user device 20C are defined as promotion of new registration into the sales promotion group, individual approaches to anonymous users in anonymity authentication can be achieved.

Additionally, the present embodiment uses a privileging system for certifying a group member of a group management institute. Then, in accordance with a use record of one's own service user, a registration promotion message for a sales promotion group capable of obtaining a half-price coupon or the like is transmitted to the user device 20C. In thus manner, an anonymous user enables a single promotion. Further, a single promotion is enabled based on individual settlement history information managed by a group management institute when a service provider wants to provide a single service to one's own service user.

A technique described in each of the foregoing embodiments can be distributed to be stored in a storage medium as a program that can be executed by a computer. Examples of the recording mediums include: a magnetic disk (such as floppy (registered trademark) disk or hard disk), an optical disk (such as CD-ROM or DVD), a magneto-optical disk (MO), and a semiconductor memory. These storage media may store a program and may be such that the stored program is computer readable. In this case, a storage format of a storage medium is arbitrary.

In addition, let us consider a case in which an operation system (OS) or middleware (MW) such as database management software or network software operates in a computer based on an instruction of a program installed in the computer from a storage medium. In this case, the OS, Mw or the like may execute part of processing operations for achieving the present embodiments.

The storage media are not limited to those independent of a computer. A memory in a computer stored or temporarily stored by downloading a program transmitted via, for example, a LAN or the Internet, is also included in a concept of the storage media.

The storage medium is not limited to one medium. Each of the processing operations according to the embodiments may be executed based on each of the programs stored in a plurality of storage media. That is, the above-described storage medium may be plural. A configuration of the storage medium is arbitrary.

A computer in the present invention executes each of the processing operations in the embodiments based on a program stored in a storage medium. The computer may be either of a single device such as a personal computer and a system in which a plurality of devices are connected via a network.

In addition, the computer in the invention encompasses a computational processing device, a microcomputer and the like included in an information processing device without being limited to a personal computer, and is a generic name of devices or apparatuses capable of achieving functions of the invention by using a program.

The present invention is not limited to the above-described embodiments. The invention can be embodied by modifying constituent elements without deviating from the spirit of the invention at the stage of carrying out the invention. In addition, a variety of inventions can be formed by using a proper combination of a plurality of constituent elements disclosed in the above embodiments. For example, some of all the constituent elements disclosed in the embodiments may be erased. Further, constituent elements over the different embodiments may be properly combined with each other.

What is claimed is:

1. An anonymity service providing system which authenticates an anonymous user device based on a group signature system for certifying that an anonymous user belongs to a group, and provides service to the user device, the anonymity service providing system comprising:
a group management institute device which manages a plurality of groups in the group signature system, a user device belonging to at least one of the groups, and a service use situation of each user device, promotes a user device to change or newly register a group in response to the use situation, and changes or newly registers a group based on a request for change or new registration received from the user device;
a service provider device which sets in advance a condition for promoting change or new registration of the group to the group management institute device, and provides service to the user device; and
a user device which, when change or new registration of a group is promoted from the group management institute device, transmits the change or new registration request to the group management institute device by means of a user's operation.

2. An anonymity service providing system according to claim 1, wherein new registration of the group is new registration into a sales promotion target group.

3. A group management institute device for use in an anonymity service providing system which authenticates an anonymous user device based on a group signature system for certifying that an anonymous user belongs to a group, and provides service to the user device, the group management institute device being communicable with both of:
a service provider device which sets in advance a condition for promoting change or new registration of the group to the group management institute device, and provides service to the user device; and
a user device which, when change or new registration of a group is promoted from the group management institute device, transmits the change or new registration request to the group management institute device by means of a user's operation, the group management institute device comprising:
a management device configured to manage a plurality of groups in the group signature system, a user device belonging to at least one of the groups, and a service use situation of each user device;
a change promoting device configured to promote a user device to change or newly register a group in response to the use situation; and
a group changing device configured to change or newly register a group based on the change or new registration request received from the user device.

4. A group management institute device according to claim 2, wherein new registration of the group is new registration of a sales promotion target group.

5. A service provider device for use in an anonymity service providing system which authenticates an anonymous user device based on a group signature system for certifying that an anonymous user belongs to a group, and provides service to the user device, the service provider device being communicable with both of:
a group management institute device which manages a plurality of groups in the group signature system, a user device belonging to at least one of the groups, and a service use situation of each user device, promotes a user device to change or newly register a group in response to the use situation, and changes or newly registers a group based on a request for change or new registration received from the user device; and
a user device which, when change or new registration of a group is promoted from the group management institute device, transmits the change or new registration request to the group management institute device by means of a user's operation, the service provider device comprising:
a group change condition setting device configured to set in advance to the group management institute device a condition for promoting change or new registration of a group in response to the use situation;
a service providing device configured to provide service to the user device in response to a group; and
a use situation transmission device configured to transmit the service use situation to the group management institute device.

6. A service provider device according to claim 5, wherein new registration of the group is new registration into a sales promotion target group.

7. A user device for use in an anonymity service providing system which authenticates an anonymous user device based on a group signature system for certifying that an anonymous user belongs to a group, and provides service to the user device, the user device being communicable with both of:
a group management institute device which manages a plurality of groups in the group signature system, a user device belonging to at least one of the groups, and a service use situation of each user device, promotes a user device to change or newly register a group in response to the use situation, and changes or newly registers a group based on a request for change or new registration received from the user device; and
a service provider device which sets in advance a condition for promoting change or new registration of the group to the group management institute device, and provides service to the user device, the user device comprising:
a screen display device configured to, when group change promotion information or new group registration promotion information is received from the group management institute device, display the promotion information on a screen; and
a change request device configured to transmit the change or new registration request to the group management institute device by means of a user's operation after the screen display.

8. A user device according to claim 7, wherein new registration of the group is new registration into a sales promotion target group.

9. A program stored in a computer-readable storage medium for use in a group management institute device for use in an anonymity service providing system which authenticates an anonymous user device based on a group signature system for certifying that an anonymous user belongs to a group, and provides service to the user device, the group management institute device being communicable with both of:
a service provider device which sets in advance a condition for promoting change or new registration of the group to the group management institute device, and provides service to the user device; and
a user device which, when change or new registration of a group is promoted from the group management institute device, transmits the change or new registration request to the group management institute device by means of a user's operation, the program comprising:
a first program code which causes a computer to execute a process of writing a plurality of groups in the group signature system, a user device belonging to at least one of the groups, and a service use situation for each user device, to a storage device of the group management institute device;
a second program code which causes a computer to execute a process of promoting a user device to change or newly register a group in response to a use situation read out from the storage device; and
a third program code which causes a computer to execute a process of changing or newly registering a group based on a change or new registration request received from the user device.

10. A program according to claim 9, wherein new registration of the group is new registration into a sales promotion target group.

11. A program stored in a computer-readable storage medium for use in a service provider device for use in an anonymity service providing system which authenticates an anonymous user device based on a group signature system for certifying that an anonymous user belongs to a group, and provides service to the user device, the service provider device being communicable with both of:
a group management institute device which manages a plurality of groups in the group signature system, a user device belonging to at least one of the groups, and a service use situation of each user device, promotes a user device to change or newly register a group in response to the use situation, and changes or newly registers a group based on a request for change or new registration received from the user device; and
a user device which, when change or new registration of a group is promoted from the group management institute device, transmits the change or new registration request to the group management institute device by means of a user's operation, the program comprising:
a first program code which causes a computer to execute a process of setting in advance to the group management institute device a condition for promoting change or new registration of a group in response to the use situation;
a second program code which causes a computer to execute a process of providing service to the user device in response to a group;
a third program code which causes a program to execute a process of writing the service use situation into a memory of the service provider device; and
a fourth program code which causes a computer to execute a process of transmitting a use situation read out from the memory to the group management institute device.

12. A program according to claim 11, wherein new registration of the group is new registration into a sales promotion target group.

13. A program stored in a computer-readable storage medium for use in a user device for use in an anonymity service providing system which authenticates an anonymous user device based on a group signature system for certifying that an anonymous user belongs to a group, and provides service to the user device, the user device being communicable with both of:
a group management institute device which manages a plurality of groups in the group signature system, a user device belonging to at least one of the groups, and a service use situation of each user device, promotes a user device to change or newly register a group in response to the use situation, and changes or newly registers a group based on a request for change or new registration received from the user device; and
a service provider device which sets in advance a condition for promoting change or new registration of the group to the group management institute device, and provides service to the user device, the program comprising:
a first program code which causes a computer to execute a process of writing group change promotion information or new group registration promotion information received from the group management institute device into a memory;
a second program code which causes a computer to execute a process of displaying promotion information read out from the memory on a screen; and
a third program code which causes a computer to execute a process of transmitting the change or new registration request to the group management institute device by means of a user's operation after the screen display.

14. A program according to claim 13, wherein new registration of the group is new registration of a sales promotion target group.
